(19) United States
(12) Patent Application Publication
(10) Pub. No.: US 2006/0113157 A1
(43) Pub. Date: Jun. 1, 2006

(54) Hub for wet multi-plate clutch

(76) Inventors: Kiyokazu Ichikawa, Fukuroi-shi (JP); Yoshio Kinoshita, Iwata-shi (JP); Manabu Sawayanagi, Shizuoka-ken (JP)

Correspondence Address: MILES & STOCKBRIDGE PC, 1751 PINNACLE DRIVE, SUITE 500, MCLEAN, VA, 22102-3833, US

(21) Appl. No.: 11/000,640

(22) Filed: Dec. 1, 2004

(51) Int. Cl. F16D 13/72

(52) U.S. Cl. 192/113.34

(57) ABSTRACT

There is disclosed a hub for a wet multi-plate clutch which is provided with an outer cylindrical portion having splines formed on the outer periphery thereof and oil holes formed through from the inner periphery to the outer periphery thereof. A stop ring is provided on the inner periphery of the outer cylindrical portion of the hub and a weir is constituted by this stop ring.

### BACKGROUND OF THE INVENTION

1. Field of the Invention

The present invention relates to a hub for a wet multi-plate clutch which is used in, for example, an automatic transmission, or the like.

2. Related Background Art

In a wet multi-plate clutch used in an automatic transmission, or the like, for example, a plurality of friction plates are attached to the outer periphery of the hub, a plurality of separator plates are respectively interposed between the respective adjacent friction plates, and these separator plates are mounted on the inner periphery of a clutch case or of a case of the automatic transmission. A lubricating oil is supplied to spaces between the friction plates and the separator plates. For example, when a piston is driven, the friction plates and the separator plates are brought into tight contact with each other to transmit friction therebetween.

FIG. 9 is a perspective view of a hub for a wet multi-plate clutch according to the prior art. FIG. 10 is a cross sectional view of the essential portion of the hub for the wet multi-plate clutch according to the prior art.

The hub 10 for a wet multi-plate clutch comprises an outer cylindrical portion 11 in a cylindrical form extended in the axial direction, and on the outer periphery of this outer cylindrical portion there are formed splines 12 and oil holes 13 are formed through from the inner periphery to the outer periphery (extended in the radial direction). On the inner side of the outer cylindrical portion 11, there are formed a plurality of ribs 14 for reinforcement.

Since the hub 10 for a wet multi-plate clutch is formed of alluminium by die casting and an inner peripheral surface 11a of the outer cylindrical portion 11 requires a draft angle, the inner peripheral surface 11a is formed to be inclined to have a greater diameter at a position closer to the end portion thereof.

However, if the inner peripheral surface of the outer cylindrical portion 11 is formed to be inclined to have a greater diameter at a position closer to the end portion thereof, the lubricating oil is caused to flow not only outwardly in the radial direction through the oil holes 13 by centrifugal force which acts upon rotation of the hub 10, but also toward the end portion along the inclined inner peripheral surface of the outer cylindrical portion 11, with the result that the lubricating oil leaks from the end portion of the outer cylindrical portion 11.

In order to prevent such an event, in the Japanese Patent Application Laid-Open No. 2000-120722, a weir is integrally formed at an end on the inner periphery side of the outer cylindrical portion of the hub. Leakage of the lubricating oil from the end portion of the outer cylindrical portion 11 is prevented by this weir.

However, in the structure disclosed in the Japanese Patent Application Laid-Open No. 2000-120722, a step for forming the weir for preventing leakage of the lubricating oil is complicated because of the draft angle to be formed by die casting, or the like, thereby complicating the manufacturing process. Also, if the weir is formed, it is not sufficient to supply the lubricating oil evenly and sufficiently since an amount of distribution of the lubricating oil to be supplied to the friction plates on the outer periphery side of the hub becomes uneven.

### SUMMARY OF THE INVENTION

The present invention has been contrived taking circumstances as described above into consideration, and an object thereof is to provide a hub for a wet multi-plate clutch which is capable of providing a weir for preventing leakage of lubricating oil by a simple manufacturing step, of supplying a sufficient amount of lubricating oil to friction plates and the like on the outer periphery side of the hub, and further of solving uneven distribution of the lubricating oil supplied onto the outer periphery side of the hub.

In order to achieve the above object, according to a first aspect of the present invention, there is provided a hub for a wet multi-plate clutch comprising an outer cylindrical portion with splines formed on the outer periphery thereof and oil holes formed through from the inner periphery to the outer periphery thereof, wherein a stop ring is disposed on the inner periphery of the outer cylindrical portion.

It is preferable that, in the hub for a wet multi-plate clutch according to the first aspect of the present invention, ribs each extended up to a position at which the stop ring is disposed are formed on the inner periphery of the outer cylindrical portion.

It is preferable that, in the hub for a wet multi-plate clutch according to the first aspect of the present invention, the stop ring is protruded up to an inner diameter side than the center of an opening of the oil hole positioned on the innermost diameter side.

It is preferable that, in the hub for a wet multi-plate clutch according to the first aspect of the present invention, the stop ring has no joint opening.

According to a second aspect of the present invention, there is provided a hub for a wet multi-plate clutch comprising an outer cylindrical portion with splines formed on the outer periphery thereof and oil holes formed through from the inner periphery to the outer periphery thereof, wherein a ring-shaped member is disposed on the inner periphery of the outer cylindrical portion.

It is preferable that, in the hub for a wet multi-plate clutch according to the second aspect of the present invention, the ring-shaped member is supported by a stop ring.

It is preferable that, in the hub for a wet multi-plate clutch according to the second aspect of the present invention, the ring-shaped member is attached by press fitting.

It is preferable that, in the hub for a wet multi-plate clutch according to the second aspect of the present invention, the ring-shaped member is attached by caulking (or clinching).

It is preferable that, in the hub for a wet multi-plate clutch according to the second aspect of the present invention, the ring-shaped member is formed of a synthetic resin.

It is preferable that, in the hub for a wet multi-plate clutch according to the second aspect of the present invention, the ring-shaped member is provided with a flexible portion, and is elastically engaged with the inner periphery of the outer cylindrical portion by means of the flexible portion.

It is preferable that, in the hub for a wet multi-plate clutch according to the second aspect of the present invention, a seal member is provided adjacently to the stop ring or the ring-shaped member.

It is preferable that, in the hub for a wet multi-plate clutch according to the second aspect of the present invention, the seal member is an O-ring or a D-ring.

According to a third aspect of the present invention, there is provided a hub for a wet multi-plate clutch comprising an outer cylindrical portion with splines formed on the outer periphery thereof and oil holes formed through from the inner periphery to the outer periphery thereof, wherein a portion in the vicinity of an opening end on the inner peripheral surface of the outer cylindrical portion or other than the ribs is formed to have a deep bottom.

It is preferable that, in the hub for a wet multi-plate clutch according to the third aspect of the present invention, the portion formed to have a deep bottom is formed to be gradually shallow toward the opening end on the peripheral surface of the outer cylindrical portion.

It is preferable that, in the hub for a wet multi-plate clutch according to the first, second or third aspect of the present invention, an opening portion of the oil hole on the inner peripheral side of the outer cylindrical portion is formed to be greater than other portions of the oil hole.

It is preferable that, in the hub for a wet multi-plate clutch according to the first, second or third aspect of the present invention, the total cross sectional area on the frontal side of the oil holes, out of the oil holes, having an opening portion in a large diameter portion on the inner peripheral surface of the outer cylindrical portion is smaller than the total cross sectional area on the frontal side of the oil holes having an opening portion in a small diameter portion on the inner peripheral surface of the outer cylindrical portion.

It is preferable that, in the hub for a wet multi-plate clutch according to the first, second or third aspect of the present invention, the total cross sectional area on the frontal side of the oil holes, out of the oil holes, disposed in an inner part is greater than those disposed in other parts.

It is preferable that, in the hub for a wet multi-plate clutch according to the first, second or third aspect of the present invention, the oil holes are provided closer to the rib than the center between the ribs.

It is preferable that, in the hub for a wet multi-plate clutch described lastly according to the present invention, the oil holes are provided closer to the ribs positioned on the opposite side with respect to the direction of rotation.

As described above, according to the present invention, the lubricating oil receiving centrifugal force caused by a rotation of the hub is caused to flow to the outer periphery of the outer cylindrical portion through the oil holes, so that the lubricating oil hardly leaks from the end portion of the hub. Such an effect can be obtained though the structure of the hub is simple and easy to manufacture. Further, the lubricating oil can be distributed to any part on the outer periphery side of the hub substantially evenly.

On the other hand, as for the oil holes, the total cross sectional area on the frontal side of the oil hole disposed in a part with a small diameter on the inner peripheral surface of the outer cylindrical portion or in an innermost part is made greater than that of the oil hole disposed in any other part. Note that the “cross sectional area on the frontal side of the oil hole” means an area of a cross section of an oil hole which is obtained by cutting the oil hole vertically with respect to the direction in which the lubricating oil is caused to flow (that is, the radial direction).

### BRIEF DESCRIPTION OF THE DRAWINGS

FIG. 1 is a cross sectional view of a wet multi-plate clutch according to a first embodiment of the present invention;

FIG. 2 is a perspective view of a hub for the wet multi-plate clutch shown in FIG. 1;

FIG. 3A is a cross sectional view of the essential portion of the hub for the wet multi-plate clutch shown in FIG. 1;

FIG. 3B is a cross sectional view of the essential portion of a hub for a wet multi-plate clutch according to a second embodiment of the present invention;

FIG. 4A is a cross sectional view of the essential portion of a hub for the wet multi-plate clutch according to a third embodiment of the present invention;

FIG. 4B is a cross sectional view of the essential portion of a hub for the wet multi-plate clutch according to a fourth embodiment of the present invention;

FIG. 4C is a cross sectional view of the essential portion of a hub for the wet multi-plate clutch according to a fifth embodiment of the present invention;

FIG. 4D is a cross sectional view of the essential portion of a hub for a wet multi-plate clutch according to a variation of the fifth embodiment of the present invention;

FIG. 5A is a cross sectional view of the essential portion of a hub for a wet multi-plate clutch according to a sixth embodiment of the present invention;

FIG. 5B is a cross sectional view of the essential portion of a hub for a wet multi-plate clutch according to a seventh embodiment of the present invention;

FIG. 6 is a cross sectional view of the essential portion of a hub for a wet multi-plate clutch according to an eighth embodiment of the present invention;

FIG. 7A and FIG. 7B are developed views of the outer peripheral surface of the hub according to the eighth embodiment, respectively;

FIG. 8 is a cross sectional view taken along the line B-B in FIG. 3;

FIG. 9 is a perspective view of a hub for a wet multi-plate clutch according to the prior art; and

FIG. 10 is a cross sectional view of the essential portion of the hub for a wet multi-plate clutch according to the prior art.

### DETAILED DESCRIPTION OF THE PREFERRED EMBODIMENTS

A hub for a wet multi-plate clutch according to each embodiment of the present invention will be described below with reference to drawings. The same referential numerals denotes the members having the same functions in all of the embodiments to be described below.

### First Embodiment

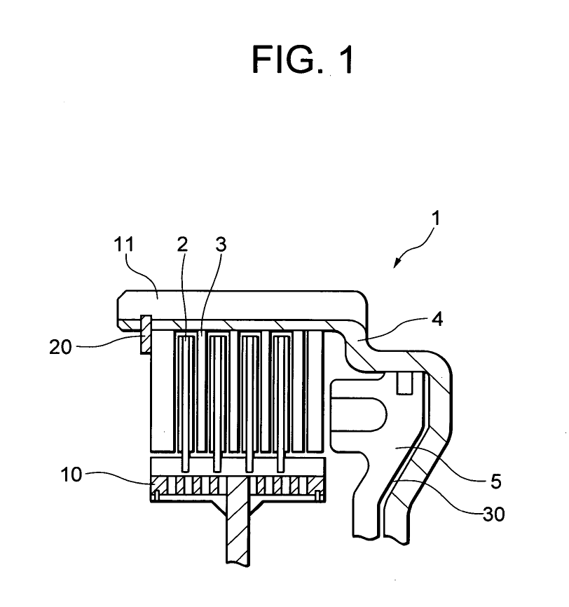

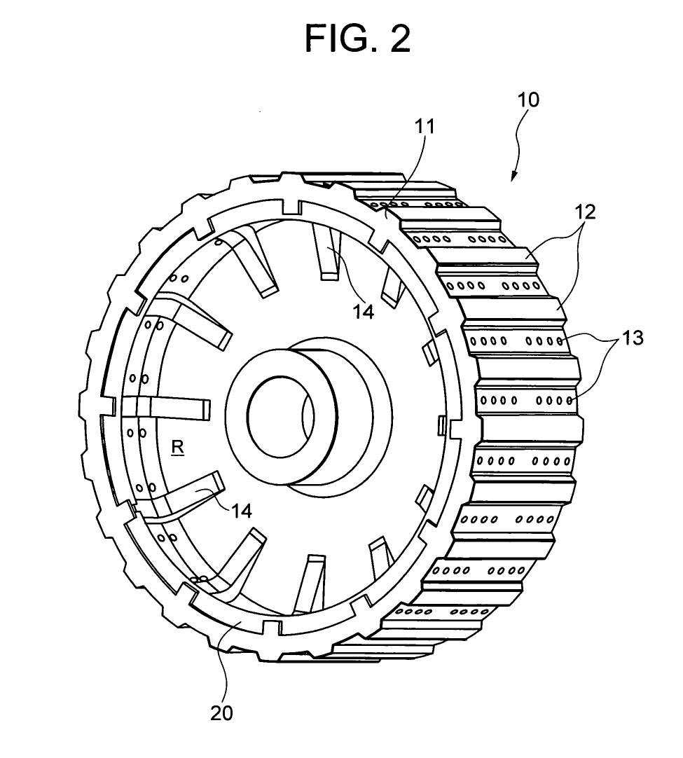

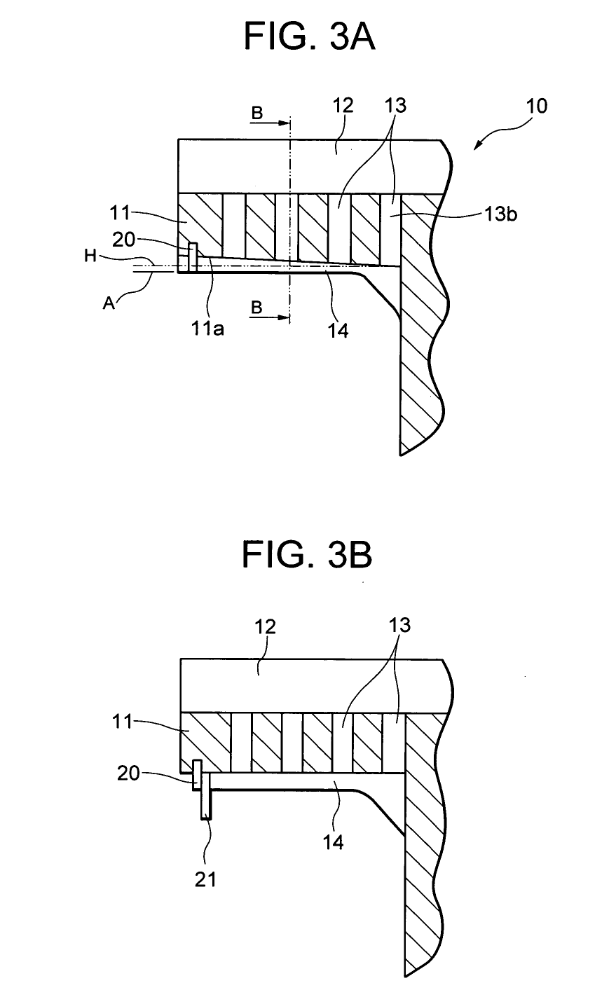

FIG. 1 is a cross sectional view of a wet multi-plate clutch according to a first embodiment of the present invention. FIG. 2 is a perspective view of a hub for the wet multi-plate clutch shown in FIG. 1. FIG. 3A is a cross sectional view of the essential portion of the hub for the wet multi-plate clutch shown in FIG. 1.

As shown in FIG. 1, in a wet multi-plate clutch 1, for example, the end portions on the inner diameter side of a plurality of friction plates 2 are attached to the outer periphery of a hub 10, a plurality of separator plates 3 are respectively interposed between each adjacent ones of the friction plates 3, and the end portions on the outer diameter side of these separator plates 3 are provided to be movable in the axial direction along splines which are formed on the inner periphery of a clutch case 4. Lubricating oil is supplied into spaces formed between the friction plates 2 and the separator plates 3. When pressurized oil is supplied to an oil chamber 30 which is formed between the clutch case 4 and a piston 5 and the piston 5 is driven thereby, the friction plates 2 and the separator plates 3 are brought into tight contact with each other to effect frictional transmission. When the pressurized oil is released from the oil chamber 30, the piston 5 is returned by an unrepresented return spring.

The hub 10 for a wet multi-plate clutch comprises an outer cylindrical portion 11 which is in the form of a cylinder and is extended in the axial direction. Splines 12 are formed on the outer periphery of this outer cylindrical portion 11 and oil holes 13 are formed through from the inner periphery to the outer periphery of the outer cylindrical portion 11 (extended in the radial direction). On the inner peripheral surface of the outer cylindrical portion 11, a plurality of ribs 14 for reinforcement are formed to be extended in the axial direction.

In the present embodiment, a stop ring 20 is disposed in the vicinity of the end portion on the lateral surface side on the inner peripheral surface of the outer cylindrical portion 11 of the hub 10, and a weir is constituted by this stop ring 20.

The plurality of ribs 14 are circumferentially formed on the inner peripheral surface of the outer cylindrical portion 11 of the hub 10, as described above, and a plurality of rooms R (FIG. 2) are defined by these ribs 14 and the stop ring 20.

Accordingly, the lubricating oil which receives centrifugal force due to a rotation of the hub 10 is caused to flow to the outer periphery of the outer cylindrical portion 11 through the oil holes 13, so that the lubricating oil hardly leaks from the end portion of the hub 10.

Also, since it is arranged that the stop ring 20 is embedded in the outer cylindrical portion 11, the hub can be manufactured in a simple process, compared with that of the conventional structure in which a weir is integrally formed.

Also, as shown in FIG. 2, by forming a joint opening of the stop ring 20 to fit on the ribs 14, it is possible to prevent leakage of the lubricating oil from through the joint opening portion.

In the manufacturing process of the hub, in some cases, a slope as shown in FIG. 3A, which forms a so-called draft angle, may be formed on the inner peripheral surface 11a of the outer cylindrical portion 11. In such cases, at least the height A of the stop ring 20 with respect to the inner peripheral surface of the outer cylindrical portion 11 is required to be more protruded to reach the inner diameter side, than the height H of the center of the oil hole 13 having an opening on the innermost diameter side.

That is, it is required to secure the height A of the stop ring shown in FIG. 3A. Note that, when there is no such a slope, it is suffice if an amount of protrusion of the stop ring 20 toward the inner diameter side is not less than 0.5 mm.

FIG. 2 shows a structure which uses a so-called C-shaped stop ring 20 having a joint opening portion. However, the stop ring is not limited to such form. A more excellent effect of a weir can be obtained by using a stop ring with no joint opening such as a stop ring with one or more turns including a double wound stop ring.

### Second Embodiment

FIG. 3B is a cross sectional view of a hub for a wet multi-plate clutch according to a second embodiment of the present invention.

In the second embodiment, the rib 14 is extended up to the vicinity of the end portion of the outer cylindrical portion 11. A ring-shaped member 21 is brought into contact with the tip end of this rib 14 so that the ring-shaped member 21 is prevented from being drawn or fallen off by the stop ring 20.

With such an arrangement, the ring-shaped member 21 exhibits the function of a weir. As a result, the lubricating oil receiving centrifugal force due to a rotation of the hub 10 is caused to flow to the outer periphery of the outer cylindrical portion 11 through the oil holes 13, so that the lubricating oil hardly leaks from the end portion of the hub 10. Since the ring-shaped member 21 is used as a weir in this structure, the manufacturing process can be simplified, compared with a structure in which a weir is integrally formed, like that of the prior art.

Note that, when there is no slope on the inner peripheral surface of the outer cylindrical portion 11, it is suffice if an amount of protrusion of the ring-shaped member 21 toward the inner diameter side is not less than 0.5 mm. The ring-shaped member 21 may be formed of a synthetic resin, instead of a metallic material of various kinds.

### Third Embodiment

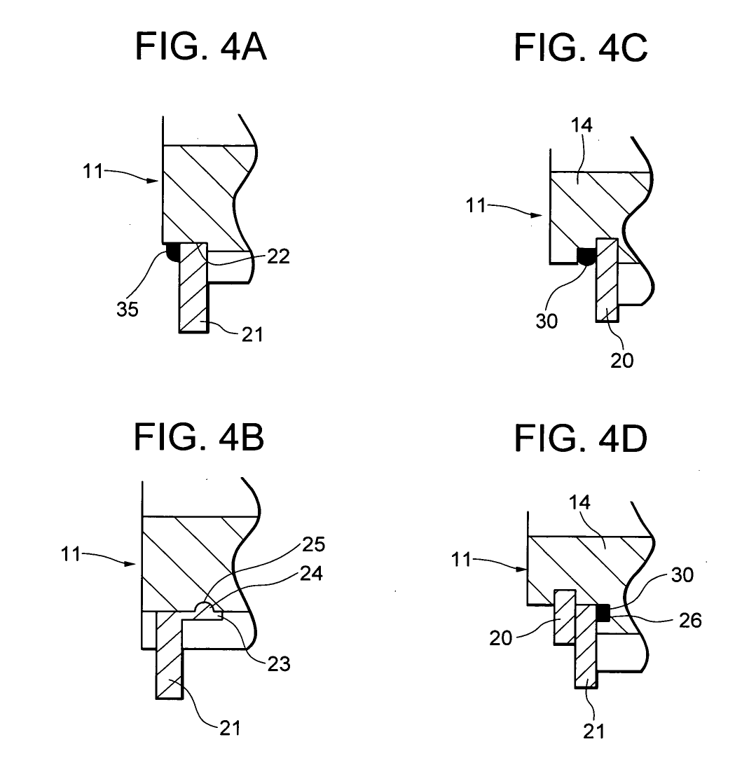

FIG. 4A is a cross sectional view of the essential portion of a hub for a wet multi-plate clutch according to a third embodiment of the present invention.

The ring-shaped member 21 is disposed in a recessed groove 22 which is formed in the vicinity of the end portion of the outer cylindrical portion 11 in the third embodiment and in each of the following embodiments to be described later.

In the third embodiment, the rib 14 is extended up to the vicinity of the end portion of the outer cylindrical portion 11, and the ring-shaped member 21 is brought into contact with the tip end of the rib 14. The ring-shaped member 21 is installed by either press-fitting or caulking (or clinching), or by both press-fitting and caulking (or clinching). A referential numeral 35 denotes a caulked (or clinched) or plastically deformed portion.

By employing such an arrangement, the ring-shaped member 21 exhibits the function of a weir. As a result, the lubricating oil receiving centrifugal force due to a rotation of the hub 10 is caused to flow to the outer periphery of the outer cylindrical portion 11 through the oil holes 13, so that the lubricating oil hardly leaks from the end portion of the hub 10. In addition, since the ring-shaped member 21 is used as a weir in this structure, the manufacturing process can be simplified, compared with a structure in which the weir is integrally formed, like one according to the prior art.

### Fourth Embodiment

FIG. 4B is a cross sectional view of the essential portion of a hub for a wet multi-plate clutch according to a fourth embodiment of the present invention.

In the fourth embodiment, a ring-shaped member 21 having a flexible portion is employed. The flexible portion is provided on an outer peripheral flange 23 of the ring-shaped member 21.

This flexible portion may be constituted by forming the ring-shaped member 21 of a synthetic resin or by providing the outer peripheral flange 23 with a slit or a notch.

A projection 24 is also formed on the outer peripheral surface of the outer peripheral flange 23, to be fitted in the recessed groove 25 which is formed on the inner peripheral surface of the outer cylindrical portion 11.

When the ring-shaped member 21 is to be installed, the projection 24 can be moved up to a position of the recessed groove 25 since the outer peripheral flange 23 serving as the flexible portion 23 is flexed to slide onto the inner peripheral surface of the outer cylindrical portion 11.

It is rendered possible to easily mount the ring-shaped member 21 onto the hub 10 by arranging the ring-shaped member 21 as described above.

Also, the lubricating oil which receives centrifugal force due to a rotation of the hub 10 is caused to flow to the outer periphery of the outer cylindrical portion 11 through the oil holes 13, so that the lubricating oil hardly leaks from the end of the hub 10. Since the ring-shaped member 21 is used as a weir in this structure, it is possible to simplify the manufacturing process thereof, compared with a structure in which the weir is integrally formed, like that according to the prior art.

### Fifth Embodiment

FIG. 4C is a cross sectional view of the essential portion of a hub for a wet multi-plate clutch according to a fifth embodiment of the present invention.

In the fifth embodiment, a seal member 30 is disposed adjacently to the stop ring 20.

A manner of installation of the stop ring 20 may be applied in either of the foregoing embodiments.

Specifically, the stop ring 20 is brought into contact with the rib 14 and the seal member 30 is disposed on the outer side thereof (that is, on the opposite side to the rib 14). An O-ring or a D-ring may be used as this seal member 30.

As described above, it is rendered possible to prevent leakage of the lubricating oil from a gap between the stop ring 20 and the inner peripheral surface of the outer cylindrical portion 11 by interposing the seal member 30 therebetween, whereby it is also rendered possible to supply the lubricating oil through the oil holes 13 more efficiently.

FIG. 4D is a cross sectional view of the essential portion of a hub for a wet multi-plate clutch according to a variation of the fifth embodiment of the present invention.

In this variation, the rib 14 is extended up to the vicinity of the end portion of the outer cylindrical portion 11, and the ring-shaped member 21 is brought into contact with the tip end of the rib 14, whereby the ring-shaped member 21 is prevented from being fallen off by the stop ring 20.

A recessed groove 26 is formed on the outer cylindrical portion 11, and the seal member 30 is accommodated in this recessed groove 26 to be brought into contact with the ring-shaped member 21. An O-ring or a D-ring may be used as this seal member 30.

As described above, it is rendered possible to prevent leakage of the lubricating oil from a gap between the ring-shaped member 21 and the inner peripheral surface of the outer cylindrical portion 11 by interposing the seal member 30 therebetween, whereby it is also rendered possible to supply the lubricating oil through the oil holes 13 more efficiently.

In this variation, the ring-shaped member 21 is fixed by the use of the stop ring 20. However, the ring-shaped member 21 may be fixed by caulking (or clinching), as in the third embodiment.

### Sixth Embodiment

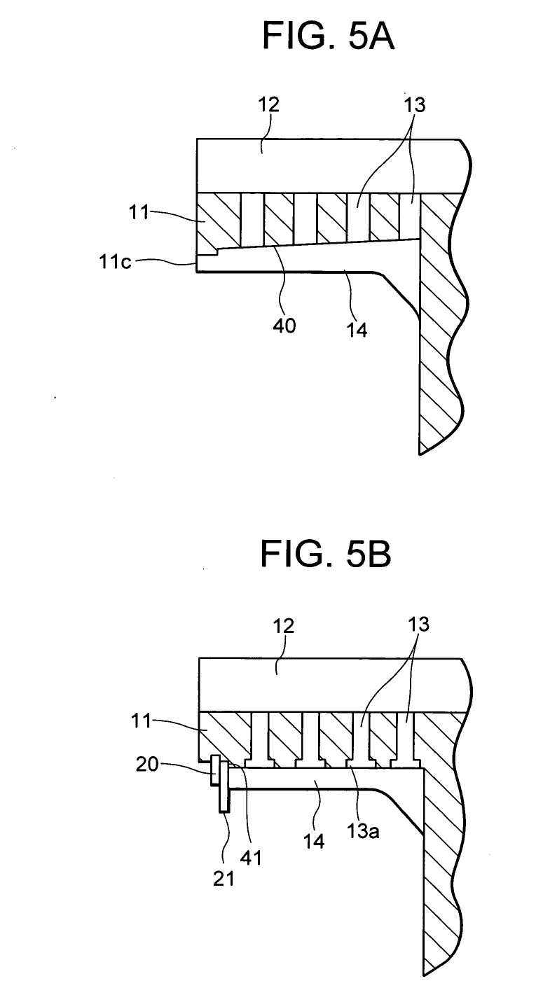

FIG. 5A is a cross sectional view of the essential portion of a hub for a wet multi-plate clutch according to a sixth embodiment of the present invention.

In the sixth embodiment, a deep bottom portion 40 is formed in a portion in the vicinity at an opening end 11c on the inner periphery side of the outer cylindrical portion 11 or in a portion other than the ribs 14. That is, the deep bottom portion 40 is formed on the inner peripheral surface of the outer cylindrical portion 11. This deep bottom portion 40 is provided with a slope so that the inner diameter thereof is gradually reduced toward an end thereof.

Note that, if there is no such a slope, it is suffice if the depth of this deep bottom portion 40 is not less than 0.5 mm. In case of the sixth embodiment, there is an effect that the lubricating oil can be sufficiently supplied even to an innermost part into which the lubricating oil is difficult to flow.

### Seventh Embodiment

FIG. 5B is a cross sectional view of the essential portion of a hub for a wet multi-plate clutch according to a seventh embodiment of the present invention.

In the seventh embodiment, an opening 13a of each oil hole 13 on the inner periphery side of the outer cylindrical portion 11 is formed to be greater than other portions of the oil hole 13.

A step portion 41 is provided in the vicinity of the end portion of the hub 10, the ring-shaped member 21 is brought into contact with the step portion 41 and the rib 14, and the ring-shaped member 21 is supported by the stop ring 20, thereby constituting the weir.

Note that the arrangement that the opening 13a of the oil hole 13 is formed greater may be applied into each of the foregoing embodiments.

### Eighth Embodiment

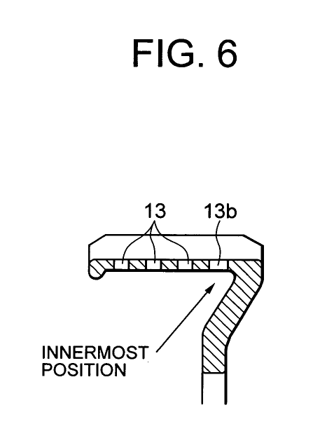

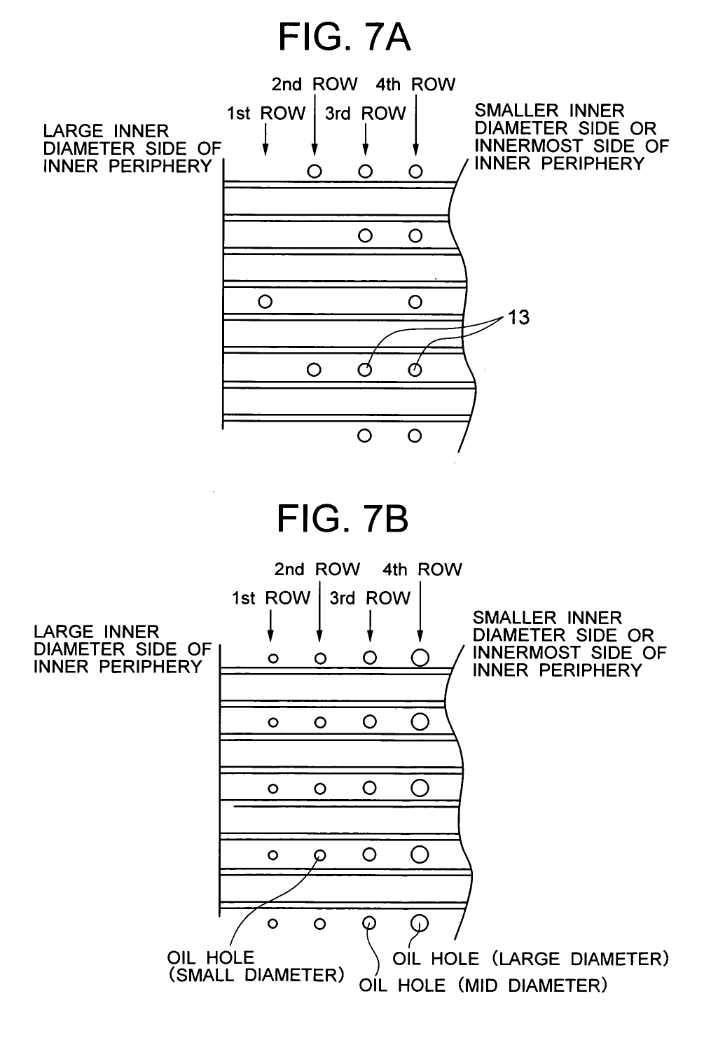

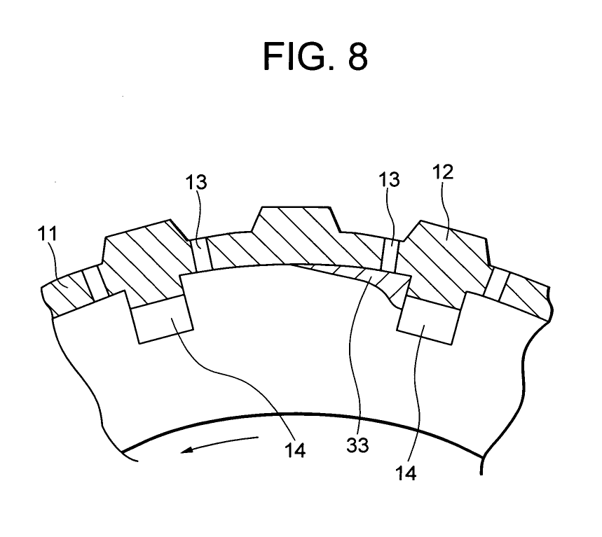

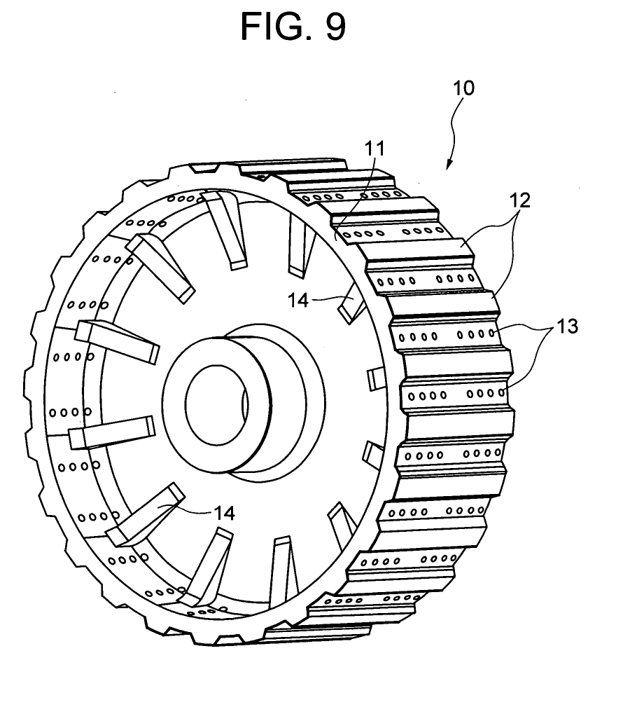

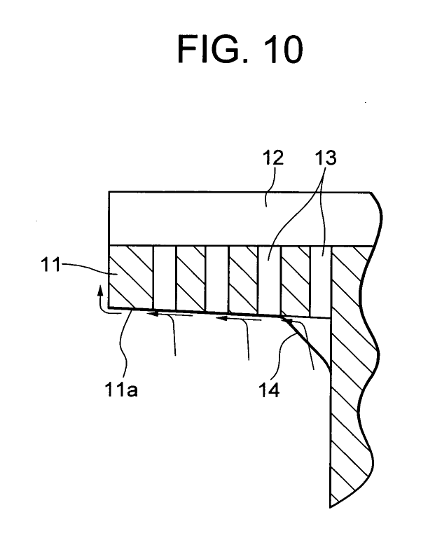

FIG. 6 is a cross sectional view of the essential portion of a hub for a wet multi-plate clutch according to an eighth embodiment of the present invention. FIG. 7A and FIG. 7B are developed views of the outer peripheral surface of the hub according to the eighth embodiment, respectively. FIG. 8 is a cross sectional view taken along the line B-B in FIG. 3.

When the hub is formed with a slope on the inner peripheral surface 11a of the outer cylindrical portion 11, like the hub 10 shown in FIG. 3A, the lubricating oil is apt to remain in the vicinity of the stop ring 20. As a result, the lubricating oil hardly reaches an oil hole 13b which is provided in a part with a small inner diameter (such as the oil hole positioned on the most right side in FIG. 3A) or an oil hole 13b formed at the innermost position, as shown in FIG. 6.

Then, in the eighth embodiment, in FIG. 6, the total cross sectional area on the frontal side of the oil holes 13 positioned on the right side in FIG. 6 is made greater than that of the oil holes positioned on the left side in FIG. 6.

As shown, for example, in FIG. 7A, the oil holes 13 are provided in a part with a small inner diameter of the inner peripheral surface of the outer cylindrical portion 11 or provided in an innermost part, which corresponds to the right side in the drawing, in a larger number than that of the oil holes 13 provided in other positions.

Also, as shown in FIG. 7B, the cross sectional area itself of the oil holes 13 positioned in a part with a small inner diameter of the inner peripheral surface of the outer cylindrical portion 11 or provided in an innermost part, which corresponds to the right side in the drawing, is made larger.

With such an arrangement, the lubricating oil can easily flow into the oil holes 13 which are provided in a part with a small inner diameter or in an innermost part. As a result, it is rendered possible to supply the lubricating oil to any position on the outer periphery side of the hub 10 substantially evenly. Also, the total cross sectional area on the frontal side of the oil holes provided in a part with a small inner diameter of the inner peripheral surface of the outer cylindrical portion 11 or in an innermost part may be enlarged by arbitrarily setting both the number of the oil holes 13 and the cross sectional area thereof.

As shown in FIG. 8, the oil holes 13 are provided closer to rib 14 from the mid position between the ribs 14. When the hub 10 is rotated, since the lubricating oil is dammed by the ribs 14, the lubricating oil 33 is dammed by the rib 14 on the opposite side with respect to the direction of rotation.

For example, when the hub 10 is rotated in the direction indicated by the arrow in FIG. 8, the lubricating oil 33 is in a stagnant state, as shown in the drawing. Therefore, if the oil holes 13 are provided closer to the rib 14 on the opposite side with respect to the direction of rotation, the lubricating oil is caused to flow into the oil holes 13 smoothly. Note that, if this hub 10 is arranged to be rotated in both of the directions, a greater effect can be obtained if the oil holes 13 are provided on both sides of the rib 14, as shown in FIG. 8.

Note that the present invention is not limited to the foregoing embodiments, but can be altered in various manners.

What is claimed is:

1. A hub for a wet multi-plate clutch comprising an outer cylindrical portion with splines formed on the outer periphery thereof and oil holes formed through from the inner periphery to the outer periphery thereof,
wherein a stop ring is disposed on the inner periphery of said outer cylindrical portion.

2. A hub for a wet multi-plate clutch according to claim 1, wherein ribs each extended up to a position at which said stop ring is disposed are formed on the inner periphery of said outer cylindrical portion.

3. A hub for a wet multi-plate clutch according to claim 1 or 2, wherein said stop ring is protruded up to an inner diameter side than the center of an opening of said oil hole positioned on the innermost diameter side.

4. A hub for a wet multi-plate clutch according to claim 1 or 2, wherein said stop ring has no joint opening.

5. A hub for a wet multi-plate clutch comprising an outer cylindrical portion with splines formed on the outer periphery thereof and oil holes formed through from the inner periphery to the outer periphery thereof,
wherein a ring-shaped member is disposed on the inner periphery of said outer cylindrical portion.

6. A hub for a wet multi-plate clutch according to claim 5, wherein said ring-shaped member is supported by a stop ring.

7. A hub for a wet multi-plate clutch according to claim 5, wherein said ring-shaped member is attached by press fitting.

8. A hub for a wet multi-plate clutch according to claim 5, wherein said ring-shaped member is attached by caulking (or clinching).

9. A hub for a wet multi-plate clutch according to any one of claim 5, 6 and 8, wherein said ring-shaped member is formed of a synthetic resin.

10. A hub for a wet multi-plate clutch according to claim 5, wherein said ring-shaped member is provided with a flexible portion, and is elastically engaged with the inner periphery of said outer cylindrical portion by means of said flexible portion.

11. A hub for a wet multi-plate clutch according to claim 1 or 2, wherein a seal member is provided adjacently to said stop ring or said ring-shaped member.

12. A hub for a wet multi-plate clutch according to claim 11, wherein said seal member is an O-ring or a D-ring.

13. A hub for a wet multi-plate clutch according to any one of claims 5 to 8, wherein a seal member is provided adjacently to said stop ring or said ring-shaped member.

14. A hub for a wet multi-plate clutch according to claim 13, wherein said seal member is an O-ring or a D-ring.

15. A hub for a wet multi-plate clutch comprising an outer cylindrical portion with splines formed on the outer periphery thereof and oil holes formed through from the inner periphery to the outer periphery thereof,
wherein a portion in the vicinity of an opening end on the inner peripheral surface of said outer cylindrical portion or other than said ribs is formed to have a deep bottom.

16. A hub for a wet multi-plate clutch according to claim 15, wherein said portion formed to have a deep bottom is formed to be gradually shallow toward the opening end on the peripheral surface of said outer cylindrical portion.

17. A hub for a wet multi-plate clutch according to any one of claim 1, claim 2, claims 5 through 8, and claims 15 and 16, wherein an opening portion of said oil hole on the inner peripheral side of said outer cylindrical portion is formed to be greater than other portions of said oil hole.

18. A hub for a wet multi-plate clutch according to any one of claim 1, claim 2, claims 5 through 8, and claims 15 and 16, wherein the total cross sectional area on the frontal side of the oil holes, out of said oil holes, having an opening portion in a large diameter portion on the inner peripheral surface of said outer cylindrical portion is smaller than the total cross sectional area on the frontal side of the oil holes having an opening portion in a small diameter portion on the inner peripheral surface of said outer cylindrical portion.

19. A hub for a wet multi-plate clutch according to any one of claim 1, claim 2, claims 5 through 8, and claims 15 and 16, wherein the total cross sectional area on the frontal side of the oil holes, out of said oil holes, disposed in an inner part is greater than those disposed in other parts.

20. A hub for a wet multi-plate clutch according to any one of claim 1, claim 2, claims 5 through 8, and claims 15 and 16, wherein said oil holes are provided closer to the rib than the center between the ribs.

21. A hub for a wet multi-plate clutch according to of claim 20, wherein said oil holes are provided closer to the ribs positioned on the opposite side with respect to the direction of rotation.
